(19) United States
(12) Patent Application Publication
(10) Pub. No.: US 2011/0035268 A1
(43) Pub. Date: Feb. 10, 2011

(54) PAYMENT METHOD AND SYSTEM

(76) Inventor: Jean-Yves Rossi, Paris (FR)

Correspondence Address: IM IP Law PLLC, P.O. Box 333, Hartsdale, NY, 10530, US

(21) Appl. No.: 12/441,453

(22) PCT Filed: Sep. 17, 2007
(86) PCT No.: PCT/FR2007/051953

§ 371 Date: Oct. 19, 2009

Related U.S. Application Data
(60) Provisional application No. 60/844,947, filed on Sep. 15, 2006.

(51) Int. Cl. G06Q 30/00; G06Q 40/00; G06Q 20/00

(52) U.S. Cl. 705/14.17; 705/40

(57) ABSTRACT

The invention relates to a method of payment by a bearer to a merchant by virtue of a means of payment, characterized in that there is carried out by successive charges, for each product, good or service presented for purchase, a charge operating between several sources of financing, and consisting of a debit from one of the sources of financing or a transfer from one of these sources of financing; and in that, with each charge, data stored in the means of payment and/or in databases of a payment server are read, these data being accessible through a link to a central system or on a local replication, said data being used by the payment server to select and then collate charging and checking rules, defined, for each source of financing, by the bearer of the means of payment or by the financer with data dependent on the characteristics: of the good, of the product or of the service presented for purchase of the conditions of the purchase, comprising for example the data, material checks made at the time of purchase, options chosen by the purchaser as well as with data emanating from a database relating to the merchants and categories of products, goods or services.

### A BACKGROUND

### A.1 Relevant Field

A.1.1 The Relevant Field Relates to all Payment Systems

The New Payment Process (Nouveau Processus de Paiement) (NP2) relates to payments, the clearing and settlements system, e-banking and to the management of loyalty points, etc.

It opens up new prospects in the field of electronic cash.

A.1.2 The Invention Relates to the Payment Process Itself

The “Nouveau Processus de Paiement” (NP2) is the product of a radical modification of the approach to payment methods.

The invention enables checks, charges, payments and settlements to be made line by line, item by item, or even price share by price share. It enables the simultaneous production of a full elementary operation report, which is as such, a processing object, which constitutes a new process, original with respect to the state of the art in that it founds a comprehensive and different e-banking system, comprised of a set of implementation tools, material media, distribution outlines, “NP2” operational methods and services, purpose of this filing, enabling new payment services to be offered. According to the invention, this NP2 set of tools enables NP2 processing chains to be performed, which opens new applications in a large number of fields.

The New Payment Process (NP2) can be implemented by means of a system, including servers, local payment and purchase terminals, payment media (cards, telephones, online sales systems, etc.), implementing the NP2 methods and programs, themselves organized within processing chains aimed at performing purchase and payment operations, by ensuring checks, charges and division between various sources of financing and production of account update data, item by item within the same payment operation.

The NP2 payment media are particular in that they can support several sources of financing or payment and integrate data defining a set of charging and checking rules, adapted with respect to the particular needs of the field, bearers, financers or merchants.

The NP2 processing chains are designed in order to convey operating reports, by elementary operation, integrating data related to the payment, but also to the object or service paid for and data relating to the checks and charging mechanisms. These reports are themselves objects of processing operations which constitute a specific element of the invention.

A.1.3 The Invention and its Implementation System Open Up New Unprecedented Functionalities Benefiting from Existing Technological Possibilities but Under-Employed in Current Systems.

Indeed, this NP2 provides an intermediate and important convenience in that it aims at creating processing chains capable of processing a set of data not limited to a price, and thus, this opens up the new possibility of using a set of new functionalities made available by current and emerging technologies, capable of powerfully and instantly carrying out processes on more and more different, secure and lightweight payment media, still lacking practical application in the field of payment, not in fact due to regulations or existing technologies, but due to the current design of payment methods and systems, which all pass via the necessary step of adding the sum to be received.

This restriction analyzed below in the description of the state of the art, is indeed one of the fundamental causes for the difficulty in developing truly innovative payment services.

### A.2 Prior Art

A.2.1 In Spite of Numerous Innovations Relating to Payment Tools, Media and Algorithms, Payment Systems and E-Banking Processes Remain Exclusively Dedicated to the Payment of a Balance, a Single Total.

The act of paying has been the subject of many inventions for several decades: the evolution of legal and banking mechanisms, development of the direct debit, impact of the Internet, development of credit cards and the chip card and the exploration of possibilities brought about by technological evolutions, etc.

However, the final process remains invariable: the act of payment is brought back to the final balance of a total calculated in “the bill”, the invoice, etc. the final step where, if necessary, the overall checks then the charge of the debit total on single account is performed.

This currently general process will be hereinafter referred to as the Classic Payment Process by Balance PCPS (Processus Classique de Paiement par Solde).

A.2.2 Miscellaneous Creations have been Conceived in Order to Compensate for the Disadvantages Emanating from this Payment Method, which Evidently Limits the Possible Functionalities.

A.2.2.1 Regarding the Charge

Card issuers offer “accounts” to which several cards are associated, issued either in the name of different bearers, or marked as “additional” cards for the same bearer in order to allow him/her to distinguish between types of expense and budgets by choosing the card used at the time of payment. Other cards even serve in supporting expenses which will be debited from an associated consumer credit account.

It is in choosing one of the bearer's cards that a charge can be distinguished. One disadvantage of this is that it leads to an increase in the number of cards held by the same person.

A.2.2.2 Regarding the Checks

The Checks Generally Relate to the Reliability of the Payment Medium Before the Requested Payment is Fully Accepted.

The checks will generally involve:
the sum to be paid or the sum of an accumulation of a given period.
the identity of the bearer and his/her verification by means of the bearer's signature or PIN number of the means of payment etc. before the requested payment is fully accepted.
the integrity of the payment medium, verification that it does not appear on the blacklists of stolen cards, individual points of compromise, etc.

Some Cards Limit the Possible Categories of Expense

Some items or some services cannot be paid for by the card and are therefore not capable of being integrated into “the bill” (for example some fuel payment cards authorizing or not the purchase of snacks or automobile accessories in service stations); the checks set-up prevent payment being made with this card.

A.2.2.3 Regarding the Sources of Financing

Some Cards Enable the User to Choose Between Two Modes of Financing

At the time of payment, some cards (for example cards issued by major outlet brand names) offering at the point of sale, the choice between direct payment or a charge to a consumer credit company (for major outlets, this is generally their consumer credit subsidiaries).

Afterwards with some banks, the customer can divide the balance or the staggering of his/her monthly debt by banking management and by virtue of cash facilities or by an associated consumer credit account.

Cards are Beginning to have Several Functions According to the Payment Terminal Used

A debit or credit card is also
a withdrawal card in an automated cash dispenser/ATM
sometimes an electronic purse
sometimes a payment card in telephone booths but for these uses, the function is always determined by the choice of terminal used (automated cash dispenser or ATM, payment terminal, Moneo or Navigo terminal, etc.); the payment medium is passive in this choice; it carries juxtaposed programs relating to the different operations.

The “Cyberwallets” Created in these Last Years Bear Several Card Reference Numbers

For some years, several Internet companies, sometimes associated with banks, have created “cyberwallets”, online storage systems which group the card reference numbers of the bearer's payment credit. These new tools can also be reproduced on cards or mobile telephones in an encrypted format. They are sometimes complemented by an electronic purse function corresponding to a prepaid fund charged by installments. In addition to the evolution of consumer behavior, the development of these tools is subject to accumulating a large enough number of agreements with banking networks and payment systems.

However, these systems only bring together in a virtual manner, the operating mode and economy of the physical payment cards. They provide a flexibility of choice and sometimes security advantages, but do not change the operating mode of credit cards, other than by making it electronic.

A.2.3 However, all of these Alternatives Compensate for the Disadvantages of the PCPS without Calling it into Question.

Regulations sometimes set restrictions which make this disassociation between the means of payment natural (e.g. regulations specific to consumer credit makes its management by dedicated “factories” natural in the banking world).

For all that, there is no denying that these restrictions, without explanation, have the effect of integrating the PCPS as an alternative to payment, and that whatever technical improvements or developments are introduced, the payment systems to-date have not called the PCPS into question.

### A.3 Problem Posed: Offering a Comprehensive System Capable of Providing Payment Services of a New Type

A.3.1 Market Participants are Expressing the Necessity of Accelerating the Evolution of the Service Offer in Terms of Short and Mid-Term Payments.

A.3.1.1 Existing Offers do not Satisfy Market Participants Anymore, Who are Aware that this Service Sector is Behind with Respect to Modern Tools

Market participants want to have new tools available to them, tools which will provide:
management facilities,
performance improvements,
cost reductions for payment systems,
and the appearance of new industrial participants, payment service providers capable of offering consumers, businesses and administrations new tools which are more elaborate, better suited to the diversity of their needs, and more secure.

The Single European Payments Area must bring about a significant evolution of the field over the 2007 to 2012 period. It must open a window of intervention via new technical rules for new service providers.

A.3.1.2 New Participants are Coming Forward

Telecom operators are regularly presented as intending to intervene on this market in the near future, with technology from then on playing a role in the execution of payments by mobile telephone. Several countries in and outside of Europe are beginning to experiment with these techniques. The major outlet industry also appears to be very interested in the prospect of offering its customers more comprehensive payment services than the single credit card issued by their consumer credit subsidiary. Various initiatives have been launched in this field in recent years, as much by major outlet distribution companies (mail order selling, superstores and hypermarkets, etc.) as by distribution participants in specialized consumer services and goods (fuel payment cards, car parking, etc.).

A.3.1.3 The European Commission has Undertaken to Ease Payment Operations and Reduce the Cost of Payments Made in Europe (European Space and the Eurozone).

The European commissioners in charge of Competition and the Internal Market have regularly denounced the inadequacies and obstacles of community development resulting in the present organization of the payment market.

Indeed, economic studies have shown that the stake on the increase in performance of payment systems represents almost 1% of the gross domestic product.

A.3.1.4 The European Central Bank (ECB) Supports and Reinforces these Initiatives

The European Central Bank (ECB) is the instigator of the creation of an electronic cash issuer and distributor status, homogeneous throughout Eurozone countries and throughout the countries of the European Union by the support of a European directive. It is also working towards creating common security standards and targets for electronic cash systems.

A.3.2 This Development Will not Originate from the Evolution of Existing E-Banking Systems, as they are all Organized Around the PCPS, and so are Designed and Dimensioned to Exchange Only a Limited Amount of Information.

A.3.3 The NP2 Inventive Design Associated with its NP2 Implementation Tools Aims at Forming One of these New Offers

A.3.3.1 Stated in a General Manner, the NP2 Turns the Payment of a Complete Operation Concentrating the Checks and Information Associated by One Point, which is the Payment of a Balance (Thus Confusing the Information Associated to Each of the Purchased Items by Preventing their Use) into a Complex and Controlled Process, Organized by a Elementary Charging Operation for Each Item Taken Separately.

The NP2 organizes payments by processing information relating to
the bearer and to sources of financing (identifiers, status, conditions of validity, charge account or budget, etc.)
the item or service (nature, description by bill(s), reference numbers in the bills of purchase, fiscal parameters, etc.)
the checks and charging rules (dependent on the nature of the item and of the associated commercial, social or regulatory parameters, the nature of the checks performed and the results obtained, etc.).

In this method, the elementary operations are reported in a 3-dimensional (or more) report, preserving the associated information (date, place, etc.) as much as necessary, line by line, item by item, transaction object by transaction object and by amount charged.

A.3.3.2 The Method Associated with the NP2 Material Elements and with the Organization Outlines and NP2 Processing Chains, Whose Invention is Claimed by this Filing, Constituting a Comprehensive Payment Service System.

It enables the execution of almost all existing payment applications by grouping them into the same surroundings.

It is rolled-out by implementing the NP2 methods in the various tools provided by existing or future state of the art, by means of NP2 software, then the implementation of a NP2 service architecture.

It adapts to a given field by analysis of the particular flows of necessary data and by setting the parameters of the NP2 tools and NP2 processing chains in order to define, in addition to elementary functions originating from the payment, the new functionalities specific to the field, taking advantage of the strengths of the method and the functionalities creating innovative value.

This NP2 will be defined in the broadest scope. Examples of application are set out at the end of this document in the fields of BtoC, BtoB and the field of public services.

Thus, the invention relates to a method of payment by a bearer to a merchant by virtue of a means of payment, characterized in that it is performed by successive charges for each product, good or service presented for purchase, a charge operating between several sources of financing and consisting of a debit from one of the sources of financing or a transfer from one of these sources of financing; and in that, with each charge, data stored in the payment means and/or in a payment server's databases are read, this data being accessible through a link to a central system or on a local replication, said data being used by the payment server to select and then collate charging and checking rules, defined for each source of financing by the bearer of the means of payment or by the financer with data dependant on the characteristics:
of the good, product or service presented for purchase,
of the conditions of purchase, comprising for example the date, material checks performed at the time of purchase and of the options chosen by the purchaser,
   as well as with data emanating from a database relating to the merchants and categories of products, goods or services.

In one embodiment, the charge can be made on a fraction of the price of the product, good or service presented for purchase, each fraction of price capable of being charged to a different source of financing.

In one embodiment, for each charge, a report is issued which associates the related charge with the recording of the data items required for checking this charge.

In one embodiment, application of the checking and charging rules serves to check the regularity and legitimacy of each charge with respect to the rules chosen by the bearer and/or the merchant and/or the financer.

In one embodiment, data management by elementary payment charges leads for each charge to the dual production, on the one hand of a settlement report issued for the payment of this charge, and on the other hand to the production and then management of a elementary charging operation report, integrating the data items resulting from the payment and the checks performed during the charge, in particular in view of its subsequent use for checks, analysis or statistical purposes.

In one embodiment, the managing of operation reports is organized in such a way that each of the addressees can receive information emanating from these reports only in the proportion of the knowledge rights specific to each addressee.

In one embodiment, loyalty points are managed on a dedicated source of financing amongst those integrated into the means of payment, the loyalty points being accumulated progressively with payments, in compliance with the charging and checking rules characteristic of the acquisition of these loyalty points, monitored with the use of reports relating to the evolution of this source of financing.

In one embodiment, the loyalty points accumulated on the dedicated source of financing can be directly used via drawing from this source of financing, in compliance with the charging and checking rules which regulate its use.

In one embodiment, a charge is made according to data representing a choice made by the bearer, in particular the choice of the source of financing to be charged, this data being either stored beforehand or captured during payment.

In one embodiment, a charge is made according to data representing the checks performed by the merchant, this data being either stored beforehand or captured during payment.

The invention also relates to a goods, products or services payment system, by a bearer to a merchant, enabling the payment to be made by successive charges for each product, good or service presented for purchase, a charge operating between several sources of financing and consisting of a debit from one of the sources of financing or a transfer from one of these sources of financing, the system comprising of:
a payment medium, specific to the bearer;
a payment terminal capable of reading and authenticating the payment medium and of transmitting the data that it contains to a payment server;
a purchase terminal capable of identifying the goods, products and services purchased and of transmitting this data to a payment server,
a payment server connected to the purchase terminal and payment terminal in order to receive data, performing successive charging operations during payment according to the data stored in the databases,
   these databases being accessible by link to a central system or on a local replication, said data being used by the payment server to select then collate charging and checking rules defined for each source of financing, by the bearer of the payment medium or by the financer, with data dependant on the characteristics:
of the good, product or service presented for purchase
of the conditions of purchase, comprising for example the date, material checks performed at the time of purchase and options chosen by the purchaser, as well as with data emanating from a database relating to the merchants and categories of product, goods or services.

In one embodiment, the payment server includes the means to make each charge on a fraction of the price of the product, good or service presented for purchase, each fraction of price capable of being charged to a different source of financing.

In one embodiment, the payment server includes the means for issuing, for each charge, a report which associates the related charge with the recording of the data items required for checking this charge.

In one embodiment, application of the checking and charging rules serves to check the regularity and legitimacy of each charge with respect to the rules chosen by the bearer and/or the financer and/or the merchant.

In one embodiment, data management by elementary payment charges enables the payment server to produce, for each charge, on the one hand a settlement report issued for the payment of this charge, and on the other hand a elementary charging operation report, this report integrating the data items resulting from the payment and the checks performed during the charge, in particular in view of its subsequent use for checks, analysis or statistical purposes.

In one embodiment, the payment server includes the means of managing operation reports, these means being such that each of the addressees can receive information emanating from these reports only in the proportion of the knowledge rights specific to each addressee.

In one embodiment, loyalty points are managed on a dedicated source of financing amongst those integrated into the payment medium, the loyalty points being accumulated progressively with payments, in compliance with the charging and checking rules characteristic of the acquisition of these loyalty points, monitored with the use of reports relating to the evolution of this source of financing.

In one embodiment, the loyalty points accumulated on the dedicated source of financing can be directly used via drawing from this source of financing, in compliance with the charging and checking rules which regulate its use.

In one embodiment, a charge is made according to data representing a choice made by the bearer, in particular the choice of the source of financing to be charged, this data being either stored beforehand or captured during payment, on the payment medium or payment terminal.

In one embodiment, a charge is made according to data representing the checks performed by the merchant, this data being either stored beforehand or captured during payment on the purchase terminal.

In one embodiment, the system includes a management interface dedicated to the bearer, including the means enabling the bearer to create and/or modify the charging and checking rules applicable and/or the sources of financing.

In one embodiment, the system includes a merchant management interface including the means enabling the merchant to create and/or modify the charging and checking rules applicable and/or the categories of goods, products or services.

In one embodiment, the system includes a financer management interface including the means enabling the financer of one of the sources of financing to create and/or modify the charging and checking rules applicable.

The invention also relates to a remote payment system of goods, products or services by a bearer to a merchant and enabling the payment to be made by successive charges for each product, good or service presented for purchase, a charge operating between several sources of financing, and consisting of a debit from one of the sources of financing or a transfer from one of these sources of financing, the system comprising of:
a means of payment, specific to the bearer, capable of grouping several sources of financing;
a purchase server, capable of identifying the goods, products and services presented for purchase by the bearer,
a payment server, connected to the purchase server, performing successive charging operations during payment, according to data provided by the purchase server and data stored in the databases,
   these databases being accessible by link to a central system or on a local replication, said data being used by the payment server to select then collate charging and checking rules defined for each source of financing, by the bearer of the means of payment or by the financer, with data dependant on the characteristics:
of the good, product or service presented for purchase
of the conditions of purchase, including for example the date, checks performed at the time of purchase and options chosen by the purchaser as well as with data emanating from a database relating to the merchants and categories of products, goods or services.

In one embodiment, the payment server includes the means to make each charge on a fraction of the price of the product, good or service presented for purchase, each fraction of price capable of being charged to a different source of financing.

In one embodiment, the payment server includes the means for issuing, for each charge, a report which associates the related charge with the recording of the data items required for checking the charge.

In one embodiment, application of the checking and charging rules serves to check the regularity and legitimacy of each charge with respect to the rules chosen by the bearer and/or the merchant and/or the financer.

In one embodiment, data management by payment charges enables the payment server to produce, for each charge, on the one hand a settlement report issued for the payment of this charge, and on the other hand a elementary charging operation report, this report integrating the data items resulting from the payment and the checks performed during the charge, in particular in view of its subsequent use for checks, analysis or statistical purposes.

In one embodiment, the payment server includes the means of managing operation reports, these means being such that each of the addressees can receive information emanating from these reports only in the proportion of the knowledge rights specific to each addressee.

In one embodiment, loyalty points are managed on a dedicated source of financing amongst those integrated into the means of payment, the loyalty points being accumulated progressively with payments, in compliance with the charging and checking rules characteristic of the acquisition of these loyalty points, monitored with the use of reports relating to the evolution of this source of financing.

In one embodiment, the loyalty points accumulated on the dedicated source of financing can be directly used via drawing from this source of financing, in compliance with the charging and checking rules which regulate its use.

In one embodiment, a charge is made according to data representing a choice made by the bearer, in particular the choice of the source of financing to be charged, this data being either stored beforehand on the purchase server or captured during payment and transmitted to the purchase server.

In one embodiment, a charge is made according to data representing the checks performed by the merchant, this data being stored beforehand on the purchase server.

In one embodiment, the system includes a management interface dedicated to the bearer, including the means enabling the bearer to create and/or modify the charging and checking rules applicable.

In one embodiment, the system includes a merchant management interface including the means enabling the merchant to create and/or modify the charging and checking rules applicable.

In one embodiment, the system includes a financer management interface including the means enabling the financer of one of the sources of financing to create and/or modify the charging and checking rules applicable.

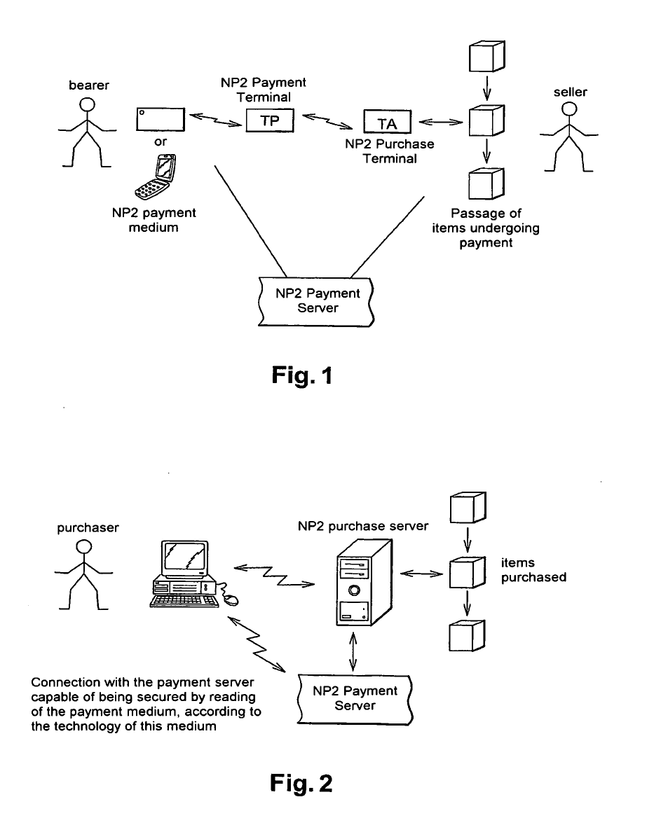

The invention will be better understood by virtue of the detailed description hereinafter, made with reference to FIGS. 1 to 7, amongst which:

FIG. 1 is an outline of the system according to the invention comprising of a purchase terminal;

FIG. 2 is an outline of the system according to the invention comprising of a purchase server;

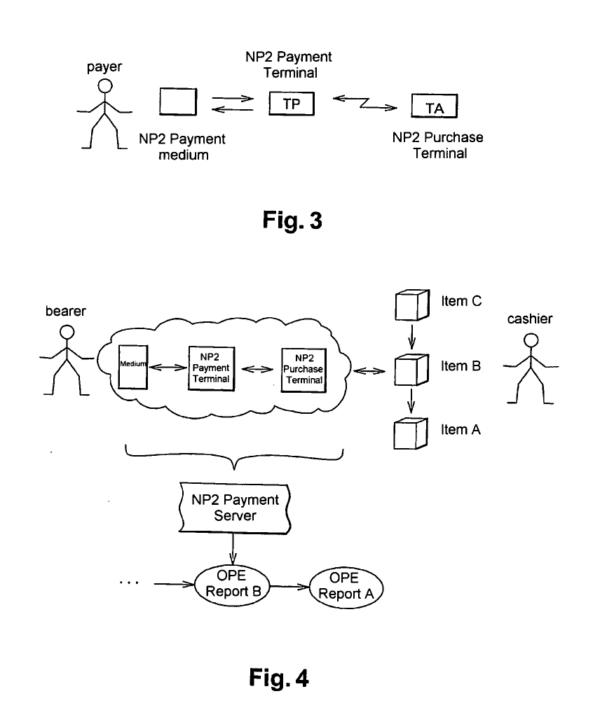

FIGS. 3 to 6 describe the different payment steps during a purchase;

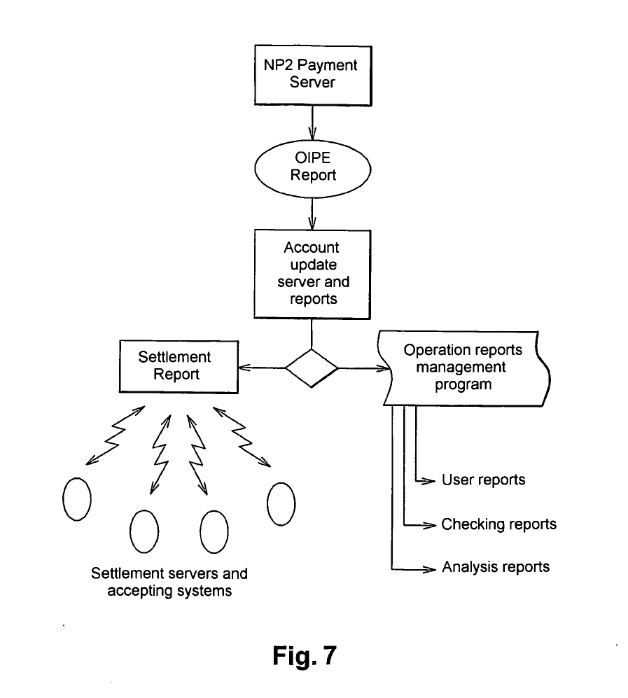

FIG. 7 describes the different settlement and account update steps resulting from a payment.

### B A New Comprehensive Device

### B.1 NP2 Elements

### B.1.1 A New Approach

All of the material and software items for the implementation of the invention have the common characteristic of organizing all the processing operations by elementary payment charging operation (OIPE—Opération d'Imputation de Paiement Élémentaire), of performing the checks dependent on the purchaser, the mode of financing and the object or service purchased for each of these operations, and then to produce an operations report specific to each OIPE.

Each OIPE results from the processing of multiple data relating to the bearer and the sources of financing that he has available, the characteristics of the purchase and the charging and checking rules.

By initial design, manager of data relating to various sources of financing, objects or services purchased and the charging and checking rules, the NP2 system includes in a characteristic manner, particular and specific software tools and processing chains.

The creation of such an e-banking payment system includes defining a group of implementation tools, materials and software dedicated to the method and architectures enabling these tools to be connected by specific processing chains.

The invention includes different, specific management tools, necessary for administration of the NP2 system and aimed at fully exploiting the new possibilities provided by this method.

### B.1.2 Definitions

The following definitions will be used in the document hereinafter

B.1.2.1 Payment Media

This relates to the material or virtual object, medium of its NP2 payment means, identifying the bearer and the information associated to him/her (date of validity, authentication mode, sources of financing, etc.).

This medium will more often be a chip card or a processor incorporated into a mobile telephone, a PDA or even an ad hoc medium, etc.

Implementation of the NP2 can be performed on the whole of the existing or future payment medium, whose software processing capacities integrate into the construction or will have been complemented by the implementation of NP2 programs and software packages. It uses outlines and circuits in compliance with the state of the art as far as networks and network tools are concerned.

B.1.2.2 The OIPE Elementary Payment Charging Operation

This relates to the elementary charging operation of the payment of all or part of a price of the same item (object or service provided, typically an item within a bill) within the same payment (a series paid by the same NP2 payment medium at the same time).

This is comprised of a group of data collated in a file or N-tuple, described below, relating to the item purchased, the payment charge, the checks performed and the act of purchase (author, place, date and time, etc.). This data is adaptable according to the application implemented. It can also be encoded and compressed.

B.1.2.3 Characteristics of the Payment

These describe the means of payment, author, payment terminal, date, time and place and any other information required in an e-banking service and in the particular event of a specific implementation.

B.1.2.4 The Purchase and its Characteristics

The purchase relates to a “bill item”, it can be related to a good, service or operating fees. It can only relate to one simple share of the price of the same object or service charged to a single source of financing. Its description can be brought to the strict minimum: a quantity and a unit price; it can be elaborated according to the needs or the scope of application, with various levels of description.

As a general rule, these characteristics are listed in reference to a bill, the latter can be in general use (Electronic Commerce Modeling Language ECML, codification used in a sector, etc.), specific to the distributor, specific to the withdrawal, agreed to by the service provider and his/her customer within the scope of a particular application (brand name loyalty payment card for particular public sectors, etc.)

B.1.2.5 The Debit and its Characteristics

In the payment process, the subject of this filing, payment can be charged item by item, or even by share of the price of an item to different sources of payment.

This multiplicity of charge is today regular practice, even if e-banking does not know how to manage in a simple manner this type of situation. The world of healthcare in France provides a characteristic example of this: third-party payer, deterrent fee, social security fund, mutual insurance company, additional benefits, extra-billing, etc. all of these claims are paid either by a “game of cards” during payment, by the management of complex updating rules at the level of the central settlement and payment systems, or even by a raised cost premium for manual management. But not yet directly by the consumer, who, if given the possibility in a technically simplified manner, is however the one who has the best view of his/her various resources (or social protection mechanisms), and must also become clearly responsible for his/her choices and judgments.

The NP2 enables the charge to be differentiated item by item as well as, at the same time, the charge to be checked or divided between sources of financing or those hereinafter referred to as the “financers”: these are above all individuals themselves, who in this method are able to charge their different purchases either to their main account normally debited from their current account, or to prepaid budgets (prepaid by themselves or by parents; friends, companies, organizations, donators), or to drawing rights available to them privately or professionally (individuals, credit establishments, public administrations, etc.); then these are banks and credit organisms either specialized or not, able to finance certain expenses to this end; and finally, these are the companies and organisms desiring to open and check the drawing rights of drawers, beneficiaries or brokers.

The last outline enables a payment service providing offer to be created, upon the initiative of the companies issuing the payment media (mobile telephones, brand or co-brand cards, RFID media or any other new payment vector), who are preparing themselves in the NP2 process, by being equipped with a compensation: for example, a position of being the holder of prepaid accounts, an electronic cash issuer status and/or a direct debit right.

In reference to the terminology emanating from the European Commission's directive project on “payment services in the internal market”, passed on Mar. 27, 2007, the charge to a source of financing can consist of a Debit on an account of the bearer or a financer, or even in a installment (or transfer) from an account or that of a financer.

B.1.2.6 OIPE Checks

The NP2 device plans for the implementation of checks at the necessary degree of precision, capable of meeting customer, retailer and distributor, and producer expectations, and the expectations of those referred to in this document as “financers” (individuals, credit establishments, public administrations, etc.). These checks can be related to:
the authentication of the bearer (of course), but in a more precise manner than with a payment means check (PIN or other), in particular including in reference to properties of the bearer in a central file or to a human resources management company (HRM) in an internal system
the purchase and its conditions such as the nature of the object or service purchased
the payment, with
   cash control: is the prepaid deposit sufficient? Is the purchased item chargeable to this source of financing? Has the limit been surpassed for this item, this financing?
   payer control. Does the author of the payment have the right, considering his/her characteristics, to pay for this type of item on this type of financing? Under which circumstances? With which related reporting?

B.1.2.7 Operating Reports and their Use

The NP2 consequently leads to the production of operation reports by the OIPE, OPE and by the act of payment, and enables the production of all other reports wanted by selection and aggregation of the data contained in the OPIE reports.

The nature and terms of production of these reports themselves constitute an important element of the invention.

These operation reports, describing the complete purchase (payment report, description of the act of payment) or of the purchase of an item (OPE report) or of the charge per item (OIPE report), normally including the checking operations report performed and its outcome.

They themselves constitute objects capable of being used for the purpose of accounting and checking (supervision or by monitoring) operations, and of budget allowance and statistics management operations, etc. and of all other processing operations in compliance with the applicable regulations, according to the case, with the consumer, the country of the merchant, the purchase or purchaser, with the public, national, community or international order rules and any other restrictions resulting from the particular application implemented.

According to the scope of application, the reports are defined, limited or extended and managed as per the rights and requirements of their addressees. This management precision constitutes one of the characteristic elements of the invention.

It is, particularly in the definition, design, development and perfecting of these management, charging and checking systems, as well as in the use of payment reports, that a new and creative payment service providing offer could develop and be of value to its customers.

### B.1.3 A comprehensive NP2 System

The NP2 system subject of this filing will be described from the implementation tools, material and software, and from the processing chains of the related information system.

The material tools for the implementation of the NP2 mechanism, described hereinafter in B2.1.1 to 4, are:
the NP2 payment medium
the NP2 payment terminal
the NP2 purchase terminal
the NP2 purchase server

The specific software tools for the implementation of the NP2 mechanism, described hereinafter in B2.1.5 to 9, are:
the NP2 payment server
the NP2 bearer management program
the NP2 merchant management program
the NP2 charging and checking rules management program
the NP2 operation reports management program, integrating the:
1. NP2 settlement server
2. NP2 operation Reports and account update server

The NP2 processing chains, use:
the NP2 data management (PFi (Porteur/Financement-Bearer/Financing), MA (Marchand/Article-Merchant/Item), RIC (Règles d'Imputations/contrôles-Charging/Checking Rules); see section B2.2.1.)
the network assets management
the bearer relations management
the merchant relations management
the payment purchasing operations
the NP2 account update and settlement operations

### B.1.4 NP2 Operators

Before beginning the detailed description of the NP2 mechanism, it is useful to specify in what manner the operators of these systems will operate in order to adapt and roll out these systems in different scopes of application. Taking into account the scope of the evolution brought about by this new method, the roll-out will assume the availability of terminals, networks, processors and conservation and data management systems very different to those currently employed in the field of e-banking, but existing or emerging in a range of other fields (telecommunications, GSM, 3G, UMTS, RFID, Internet, etc.). One of the first tasks of the NP2 operators therefore includes implementing these methods in different tools, chosen by the issuer, then integrating itself into the same processing chain.

Software developed for this purpose is held in compliance with the rules set in terms of electronic cash (security, transparency and confidentiality, anti-laundering campaign, etc.) such as those resulting in particular from the rules and criteria enacted by the central banks (at the forefront of which being the European Central Bank) and the international payment systems. In particular, they will be developed in reference to the security objectives and models resulting from the COMMON CRITERIA METHODOLOGY established in May 2003 by the European Central Bank (ECB).

Full exploitation of these new possibilities thus offered will require for each new scope of application, a specific analysis of the objects, mechanisms and rules etc. in order to define and set-up the processing chains and management tools suitable for the field. This preliminary roll-out phase will include a condition required for success and one of the components of the NP2 operator's job.

### B.2 the NP2 Mechanism

B.2.1 The Implementation Tools

B.2.1.1 the NP2 Payment Medium

The NP2 is equally applicable to any payment medium once this payment medium, borrowed from the existing art, will have, by construction or implementation, integrated the elements of the NP2 method.

The medium can be constituted by a magnetic card or chip card, a mobile telephone, an RFID medium or any other existing or future medium used for payment applications, once these payment applications are resistant to being copied or falsified, and that it constitutes with the reading terminal, a unit equipped with suitable and secure identification and authentication systems with a sufficient archiving capacity (for record taking of payment and memorization of operation reports) and sufficient computing capacity (for checks and charges).

B.2.1.2 the NP2 Payment Terminal

The NP2 payment terminal serves in reading, authenticating and validating the NP2 payment medium; in connection with this medium and with the NP2 purchase terminal or purchase server, and with the NP2 payment server, it constitutes the unit carrying out the payment according to the elementary payment charging process.

The NP2 is equally applicable to any payment terminal once this payment terminal, borrowed from the existing art, will have, by construction or implementation, integrated the elements of the NP2 method.

For some applications and on some terminals, an interactive screen (of touch screen type) can be installed, to which the use of the interface of an intelligent mobile medium (PDA, Smartphone) can be substituted; this interface will enable, for some fields and according to the options programmed for the charging rules being applied, the examination of the bearer which will thus be capable of directing different purchases towards different sources of financing.

The NP2 payment terminal, borrowed from the existing art, must be capable of cooperating with all NP2 payment media capable of being used in the scope of application.

Whatever the medium, the operating unit formed once the NP2 medium has been put in connection with the NP2 payment terminal, must satisfy all security requirements applicable to the field of e-banking. The NP2 medium and payment terminal must constitute a unit equipped with suitable and secure identification and authentication systems with a sufficient archiving capacity (for record taking of payment and memorization of operation reports) and sufficient computing capacity (for checks and charges).

B.2.1.3 the NP2 Purchase Terminal

The NP2 purchase terminal (see FIG. 1) serves in reading and identifying the object of the purchase, then after transmission of this data to the NP2 payment terminal, serves in performing the checks and applying the charging rules by the NP2 payment server.

The NP2 purchase terminal is a sales terminal such as those existing in the exits of sales areas (typically the check-out of a supermarket, shop or service station, etc.) equipped with an automatic or manual capturing mechanism of the object or service purchased (bar code reader, RFID reader, automatic check-outs dedicated to a range of products, with pre-programmed buttons or touch screen, etc.) complemented by construction or implementation of NP2 functions, serving to:
identify the object of the purchase,
read on the object, in its memory, or recover on a server, the characteristics of this object necessary for the elementary charging operation of the NP2 payment,
then transmit them to the NP2 payment terminal so that the NP2 payment server,
   in relation to data related to the bearer and to the modes of financing,
   after having examined the bearer if necessary on the charging options, via the interface of the payment terminal or that of the payment medium,
   performs the application of the checking and charging rules,
   and can thus proceed to the successive OIPE regulations
   and perform the operation reports in view of their transmission.

According to the scope of application, the purchase terminal can include a seller interface enabling him/her to specify different particular parameters item by item, on which the charging or management rules, etc. can rely.

In some applications, this interface can also serve in examining the bearer, in particular on his/her choice of charge, either directly or via the interface of the NP2 payment medium or of the NP2 payment terminal.

The NP2 is equally applicable to any purchase terminal, once this purchase terminal borrowed from the existing art, will have, by construction or implementation, integrated the elements of the NP2 method.

The NP2 purchase terminal, borrowed from the existing art must be capable of cooperating with all NP2 tools used in the scope of application. Whatever the object or service purchased, the operating unit formed by the purchase terminal once connected to the NP2 payment terminal and, via this to the NP2 payment medium, must satisfy all security requirements applicable to the field of e-banking. The NP2 medium, purchase terminal and payment terminal must constitute a unit equipped with suitable and secure identification and authentication systems with a sufficient archiving capacity (for record taking of payment and memorization of operation reports) and sufficient computing capacity (for checks and charges).

B.2.1.4 the NP2 Purchase Server

The NP2 purchase server (see FIG. 2) is the tool for applying NP methods to online purchase operations.

Constituting an NP2 purchase server, any online sales server which, by construction or by implementation, includes the NP2 payment functionalities, that is to say mainly the transmission of data relating to the object of the purchase to the NP2 payment server, in particular of data necessary to perform of the checks and apply the charging rules.

The NP2 purchase server can operate as a user of an external NP2 payment server to which it will be connected for the requirements of the operation, or even include an NP2 payment server; in this second outline, the NP2 purchase server should, by means of a secure connection, communicate with the NP2 payment server or even directly with the NP2 payment medium in order to be able to make the NP2 payment server perform the elementary payment charging operations and record the operation reports, that is to say:
identify the object of the purchase,
recover the characteristics of this object necessary for the elementary charging operation of the NP2 payment,
then transmit them to the NP2 payment server so that,
   in relation to data related to the bearer and to the modes of financing,
   the checking and charging rules are then applied,
   the successive OIPE payments are recorded
   then the operation report transmissions are performed

The purchase server can include, according to the scope of application, a purchaser interface enabling him/her to input online or a seller interface, enabling an operator to specify the different individual parameters item by item, on which the charging or management rule, etc. can rely.

The NP2 is equally applicable to any purchase server, once this purchase server borrowed from the existing art, will have, by construction or implementation, integrated the elements of the NP2 method.

The NP2 purchase server, borrowed from the existing art must be capable of cooperating as much as required with all NP2 tools used in the scope of application.

Whatever the object or service purchased, the operational unit formed by the purchase server once connected to the NP2 payment server and, via this to the NP2 payment medium, must satisfy all security requirements applicable to the field of e-banking. The NP2 payment medium, purchase server and payment server must constitute a unit equipped with suitable and secure identification and authentication systems and with a sufficient archiving capacity (for record taking of payment and memorization of operation reports) and sufficient computing capacity (for checks and charges).

B.2.1.5 the NP2 Payment Server

The NP2 payment server is the software tool which performs the NP2 payment from data received relating to the object of the purchase, in particular from data necessary to perform checks and apply of the charging rules.

Connected to the NP2 purchase terminal or to the NP2 purchase server and to the NP2 payment terminal, it is the NP2 payment server that performs the elementary payment charging operations and records the operation reports, that is to say:
in relation to data related to the bearer and to the modes of financing,
according to the characteristics of the item and the checking and charging rules applicable
the application of these rules and checks
then the recording of the successive OIPE reports
then the transmission of the operation reports to the NP2 operation reports management program.

The NP2 purchase server must be capable of cooperating with all NP2 tools used in the scope of application

Whatever the object or service purchased, the operational unit formed by the purchase server once connected to the NP2 payment server and, via this to the NP2 payment medium, must satisfy all security requirements applicable to the field of e-banking.

The NP2 payment medium, purchase server and payment server must constitute a unit equipped with suitable and secure identification and authentication systems and with a sufficient archiving capacity (for record taking of payment and memorization of operation reports) and sufficient computing capacity (for checks and charges).

B.2.1.6 the NP2 Bearer Management Program

The NP2 bearer management program serves in initializing, organizing and managing the payment medium.

It operates as a read/write interface of the NP2 payment medium available online by connection to an NP2 bearer relations management server or to a reading terminal or to the network assets management server of the issuer of the NP2 payment medium.

The NP2 payment medium includes a main account by means of which the bearer or a broker or beneficiary of the bearer (bank, company issuing the payment media, telecom operator, etc.) are held to the payment of debts resulting from payments by this medium. This payment guarantee will be capable of being applied, in particular by direct debit.

The NP2 payment medium can offer a range of other sources of financing which are typically other debit right reference numbers, payment means or prepaid accounts, etc.

The bearer management program enables
the creation, funding, charge, monitoring of prepaid allowances,
the setting of charging rules towards dedicated budgets, either automatically or by means of the purchase terminal interface as an option during payment
the possibility for some allowances or categories of expense of providing for the bearer to be examined on his/her charging choices at the time of payment
the management of drawing rights and support from which the bearer may benefit,
the management of professional expenses,
the definition and management of checks and restrictions which he/she decides upon, etc.

The NP2 bearer management program is normally accessible via the bearer relations management server.

B.2.1.7 the NP2 Merchant Management Program

The NP2 merchant management program serves on the one hand in managing the Merchant/Item (MA—Merchand/Article) database, It serves on the other hand as a parameter setting interface of the NP2 purchase terminal or purchase server.

It enables the merchant to organize his/her purchase terminals and servers:
perfection of point of sale interfaces,
management of the characteristics of the objects and services sold
as well as the associated checks and restrictions,
perfection of promotional offers (gift certificates, reductions in general or specific to customers or sources of financing—such as prepaid offers for certain customers or on certain items, etc.) by drawing up new rules within the RIC database
offers associated with financing (staggering of payments, connection with specific consumer credits, etc.) etc.

According to the architecture of the chosen implementation, the merchant management program can be accessible on a dedicated server in connection with a network assets management server or with an NP2 operator server. It will connect to the server of this operator for the transmission of new RIC rules associated with its promotional operations, so that these are spread in the implementation architectures via the network assets management server.

B.2.1.8 The NP2 Charging and Checking Rules Management Program

The NP2 charging rules and checks management program serves in defining the charging and checking rules, administrating them in the rules and checks database (RIC), then in distributing them in the implementation architecture by reading/writing of NP2 servers and tools, NP2 payment media and reading terminals.

These last operations are normally performed via the network assets management server.

It enables the relevant parties to define and organize, each as far as is concerned, the rules, checks, restrictions and reporting mechanisms desired.

The application of these rules and their update is ensured, operated and checked in real time by connection to useful servers, that is to say by periodic propagation of the parameters on the elements of the NP2 processing chain, according to the choice of implementation architecture.

B.2.1.9 The NP2 Operation Reports Management Program

The NP2 operation reports management program receives from the payment servers, operation reports of elementary payment charges (ROIPE—rapports d'opérations d'imputation de paiement élementaire), stores them and then processes them for distribution, according to the implementation architecture, towards on the one hand, the settlement and payment servers and on the other hand towards the NP2 account update server.

As previously indicated, use of the payment reports can occur according to the scope of application: accountancy management, checks, drafting of management reports and budget execution reports, adaptation of management and checking rules, targeting in electronic commerce, commercial studies, targeted promotional actions, etc.

The method aims in particular at creating value by reducing administrative costs and by easing checks by the development of managing the metadata associated to each purchase, at the useful level of the granularity of the information.

Due to its design, the method enables the output of operation reports to be programmed, integrating all applicable restrictions in terms of confidentiality, operation secrecy, transparency and anti-laundering campaign Data is transmitted to the different users (payer, financer, seller, etc.), via the NP2 account update server, after manufacturing and formatting by the NP2 operation report management program and in compliance with applicable confidentiality legislations and rules according to the scope and application.

B.2.2 NP2 Information Systems

Their description is given hereinafter
from data managed
from processing chains: during payment, during settlement operations, for system management,
from various implementation architectures

B.2.2.1 Data Managed

The data managed and integrated into an e-banking process must, to this end, be compliant with the rules imposed by the regulators.

It is stored on different elements of the processing chain, according to the architecture of the retained roll-out, the nature of the media and terminals and the particular scope of application.

Their format is variable according to the scope of application, in the state of the art and as a general rule, it is particularly capable of being XML encrypted.

PFi (Porteur/Financement) Bearer/Financing Characteristics

Data relating to different financings supported in an NP2 application will use the professional norms.

Data must be managed in such a way as to satisfy the multiple confidentiality requirements, transaction secrecy, transparency and knowledge from end to end, necessary for the anti-laundering campaign, at the suitable levels, according to the scope of application and the type of payments insured, as well as that the user made addressee of any report containing this type of information.

MA (Marchand/Article) Merchant/Item Characteristics

The Merchant/Item characteristics are the data which until now has normally been inexistent or rudimentary in the existing e-banking processes and processing chains.

However, in the NP2, their availability is necessary at varying levels of detail according to the scope of application, for the execution of associated charging and checking operations.

This descriptive data will be either retaken from the pre-existing bills in the scope of application, or defined ad hoc for the NP2 payment application installed on a field, during the analysis phase prior to roll-out.

Typically, the management of item data will borrow from the state of the offer by systems of supply chain management, so as to apply them to the NP2 e-banking applications and process.

RIC (Règles Imputation/Contrôles) Charging/Checking Rules

the process called the creation of rule tables used for the elementary checks and charges, depending on the object or service purchased (item), of the bearer, the source of financing and data captured at the time of purchase, associated to the conditions of the latter.

this data includes in a simple manner, the rules already used in the field of e-banking (restrictions, periods of validity, checking lists of stolen cards or payment media, etc.) but are extended to the rules specific to the NP2 process, necessary for its operation, in particular the charging rules for all or part of the price of the item between different sources of financing managed and presented by the payment medium.

Operation Reports

The operation reports are, according to the NP2 method,
structured in the most precise way, by Elementary Payment Charging Operation (OIPE—Opération d'Imputation de Paiement Élémentaire)
they gather useful data relating to
   the item purchased,
   the bearer and nature of the medium,
   the description of the payment conditions (date, place, etc.),
   the reference numbers of the source of financing and of the final payer,
   the share of the price charged in the OIPE,
   the reference number of the checks and charging mechanisms performed during the payment operation with their outcome and the associated data captured by the seller or purchaser during the payment,
   etc.
any other information particular to the processing and scope of application

These reports are reprocessed by the operation reports management program, before transmission towards the different users, in order to be adapted to their specific requirements and made compliant with all confidentiality requirements.

The storage of comprehensive data by the NP2 operator enables him/her to play the role of a trusted third party and efficient participant in the anti-laundering campaign.

B.2.2.2 Descriptive Outline of NP2 Processing Chains

At this stage, the steps of a payment operation, consecutive settlement operations and various implementation architectures are successively presented.

Payment Steps

The term “payment” refers to the operations performed by the bearer of an NP2 payment medium, in a place and time, for the payment of one or several items, objects or services by means of an NP2 payment terminal.

Step 1: The Payer is Identified (See FIG. 3)

The payer connects his/her NP2 payment medium to the NP2 payment terminal (which operates in connection to a central server or in an asynchronous operating mode). It proceeds to an authentication according to one of the methods of the existing art.

The operations are then performed on the basis of the information contained in the payment medium, complemented as required by information available on the central site.

The payment terminal connects to the NP2 purchase terminal or the NP2 purchase server.

Step 2: The Items are Presented for Payment (See FIG. 4)

The items presented for payment by the bearer during the purchase are read by the NP2 purchase terminal according to one of the numerous existing methods (laser bar code reader, RFID, manual identification by the seller or cashier, etc.).

According to the application, the information associated with the recovered item varies; it is or is not restricted to the information read by the purchase terminal, complemented as much as required by data available on the item or on a purchase server, and by the information captured at the point of sale by the cashier.

The information is therefore sent to the NP2 payment server, whether this is a central server or a server implemented into the NP2 payment terminal (or the purchase terminal), so that this NP2 payment server performs the OPIEs.

Step 3: The OPE is Ensured and Checked Item by Item

The NP2 payment server thus is equipped with two of the three data series necessary for the NP2 process:
the data relating to the item,
the data relating to the bearer and the sources of financing to which he/she has access,

It thus calls, according to these elements, data relating to the checks and charging rules. This data originates from the payment medium and the purchase terminal, complemented as required by other extracts from the central server.

According to these rules, the price of the item presented is broken down between the different sources of financing available.

During the OPE, the NP2 process performs the allocation of the expenses relating to the item to one of the available sources of financing, according to the charging rules thus met.

The charge will only be performed after the planned checks in step 4 have been performed, whether they relate to the item, mode of financing, rules combining this data or other data determined by the data relating to the checks and charging rules included in the payment medium, the checkout reader or the NP2 processor itself.

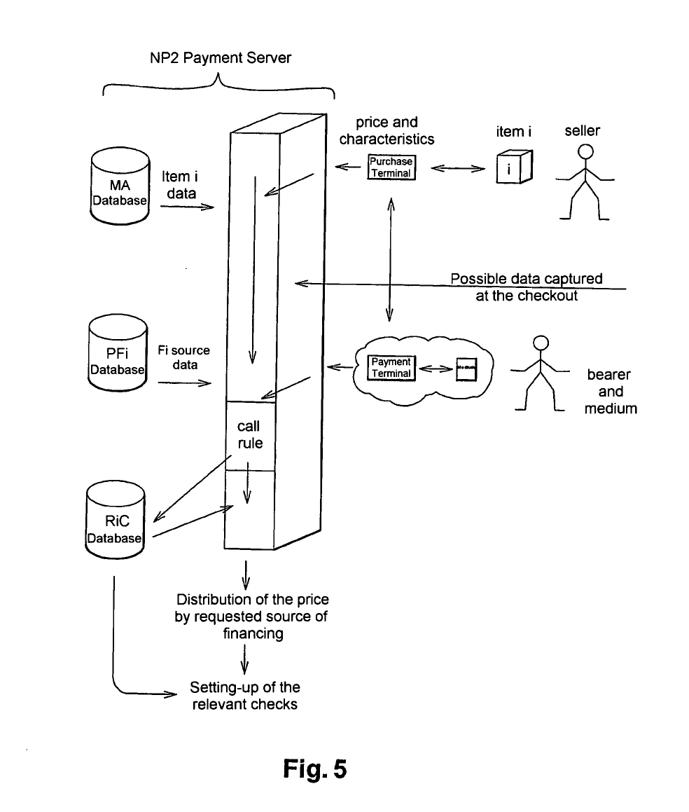

Step 4: The Payment is Charged to the Various Sources of Financing (See FIG. 5)

The NP2 payment server is thus equipped with all elements in order to perform the OIPE(s) relating to a given item.

The charge is nevertheless only performed after the planned checks have been performed, whether they relate to the item, mode of financing, rules combining this data or other data determined by the data relating to the checks and charging rules included in the payment medium, the checkout reader or the NP2 processor itself.

If the conditions are not met, either the charge is made to the main account, that is to say the account on which the bearer of the payment medium is held to honor his/her elementary debt (prepaid account within the limitation of the credited amount or direct debit right agreed to by the bearer to the operator), or the sale is refused and the item withdrawn (unauthorized purchase).

If all the conditions are met, the allocation of the expenses relating to the share of the price of the item to one of the available sources of financing is performed according to the charging rules thus met and applied.

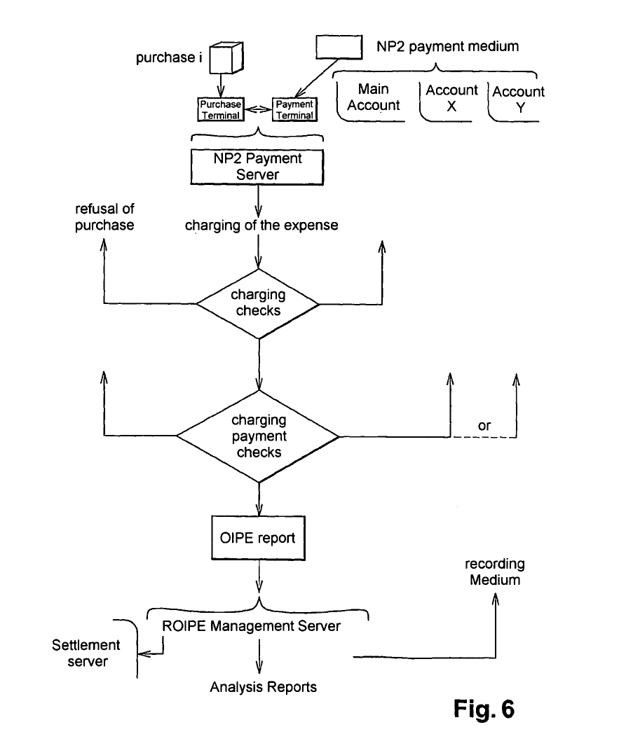

Step 5: The OIPE Operation Reports are Stored or Transmitted (See FIG. 6)

The operation report—emanating from the OIPEs, groups together for each element, the data relating to the payer, the payment, the financing charged and associated amount, as well as the descriptive data of the item and the rules applied which are useful to the application.

This report is stored either in the payment means or in the central server. The data is transmitted by the NP2 account update server to the different users (bearer, payer, financers, seller, etc.) according to the application requirements and in compliance with confidentiality rules and applicable legislations.

It is the processing of these operation reports that enables the settlement of payments, performed by processing operations according to the architecture adopted for the scope of application.

Steps of the Settlement and Account Update (See FIG. 7)

According to the implementation architecture, the settlement of charges and payments is performed in real time or in an asynchronous manner. The centralized mode corresponds to a classic customer server outline. It enables all checks to be performed in real time. It supports the advantages and disadvantages of central architectures (cost and availability restrictions, security guarantees, etc.).

The asynchronous mode uses the possibilities acquired by the most efficient e-banking architectures (management of suspensions, resistance to breakdown, distribution and replication of information between the servers, etc.).

This implementation means is not an element of this invention, it is only an alternative means according to the choice of implemented media, whose method is only a simple user.

In these two examples, the essential steps are identical; the particularity of a process performed from operation reports at the level of the charge is shared by the two architectures.

Step 1: The OIPE Report Sent to the NP2 Operation Reports Management Program

The payment server that performs the OIPEs, whether it is integrated into the payment terminal, purchase terminal or purchase server, transmits in real time or in asynchronous mode, the OIPE reports to the account update server and the ROIPE reports where the NP2 operation reports management program is integrated.

Step 2: The NP2 Operation Reports Management Program Generates a Settlement Operation Report from the OIPE Reports

Upon receipt of this report, after storage and archiving operations for legal and back-up purposes, the NP2 operation reports management program proceeds firstly to the settlement operation. To do this, it calls for the distribution lists for the reports to be generated upstream of the operation. This program firstly generates, from the report and according to these rules, an elementary settlement operation report, corresponding to the elementary charge amount, referencing the issuer and the beneficiary, for transmission to an accepting settlement network.

Step 3: The Operation Reports Management Program Sends a Settlement Operation Report to the Settlement Server

According to the architecture choices, these reports are transmitted:
either progressively with the processing for each OIPE
or temporarily stored to be periodically transmitted by aggregates reassembling, for a given period, the operations which relate to the same beneficiary or drawing.

The settlement operation reports are transmitted without delay to the different settlement systems to which the NP2 settlement server is connected, according to the rules and formats of each of these systems.

Step 4: The OIPE Reports Stored by the Program are Used by the NP2 Account Update Server in Order to Generate the Other Operation Reports

After transmission of the settlement report, the NP2 operation reports management program proceeds to drafting the other operation reports. The nature and format of these other reports to be generated upstream of the operation are specified in the NP2 account update server.

Due to its design, the method enables the output of the operation reports to be programmed, integrating all applicable restrictions in terms of confidentiality, operation secrecy, transparency and anti-laundering campaign.

Data is transmitted to the different users (payer, financers, seller, etc.), via the NP2 account update server, after manufacturing and formatting by the NP2 operation reports management program and in compliance with applicable confidentiality legislations and rules according to the scope and application.

Implementation Architectures

In the method, the implementation modes are adaptable according to the field, tools and media used, available connections and number of parties involved.

Implementation Modes

Relating to the communication systems used for the implementation of the service, the NP2 material payment operation is barely distinguishable from a classic payment by card or any other material or online medium.

The difference, which resides in the nature of the information processed and the operations performed, remains fully transparent to the user.

It therefore has the effect of requiring debit needs and storing and processing speeds higher than those used in e-banking today. Such requirements are from now on made easily accessible by the existing state of the art, in terms of communications, internet protocols, RFID, etc.

The determination of the network implementation architecture on a given scope of application depends on the particularities of this scope of application and the technology available.

Mainly, the specific elements associated to the choice of an NP2 method relate to the volumes of data used and the necessity of operating on the fly, the checking operations and charging operations on the different sources of financing, such as those offered by the NP2 payment medium. As a result, the process can be implemented just as effectively in topologies organized around centralized servers as in asynchronous use outlines.

The choice in the number of parties in a processing chain will have another effect, the NP2 process providing a new flexibility for this purpose.

The Role Divisions Between Operators, Merchants, Financers and Credit Establishments

The implementation topologies can be designed for two, three or four or more parties.
For two parties, this corresponds to direct producer or distributor relations with the consumer.
For three parties, this corresponds to the intervention of a third party payment service provider between the seller and the purchaser.
For four parties, this can correspond to
   a current classic outline of e-banking (buyer retailer, buyer's bank, card issuing bank, bearer customer)
   or to a similar outline for the three-party outline, by integrating the intervention of an associated bank, either to the retailer or to the customer.

Other outlines organized between the different stakeholders of the same sector are possible, in the scope of applications specific to a field (for example the fields of healthcare or assistance to senior citizens), they can group an even higher number of parties.

The New Role that the NP2 Operators can Play.

The logics of the NP2 method consists in only determining the architecture of a new payment service on a given field after analysis of its operating requirements for application, and after definition of the networks, terminals and material media implemented for the construction of the processing chain.

The definition of this topology leads to setting a usage architecture divided between the stakeholders of the system, the accommodation and management roles of the different servers and the administration roles of different applications and databases.

At first, there is a large amount of freedom in determining this architecture, but it is however subjected in practice to two types of restrictions: those originating from the tools and systems available at the premises of the different partners and their levels of performance; and those originating from numerous regulatory restrictions applicable to the material.

The first role of the NP2 service provider naturally consists in providing its know-how in the design and roll-out phases of the processing chains. This service provider can naturally also be responsible for the implementation of these servers and for the management of certain NP2 programs, as per the roles which the stakeholders of the processing chain wish to entrust it.

This results from the design of the method itself, but also from several regulatory restrictions applicable to this type of operation, the service provided in terms of electronic cash and in more general terms, to the financial services of this nature, which the outlines entrusted to the NP2 service provider, the piloting of payment service programs, administration and management of databases, the respect of the account updating program, conservation of the ROIPEs and use of the reports produced by the operation reports management program could prove to be particularly relevant.

Indeed, this diagram places the service provider in a position of “trusted third party”, the role under which he/she will be the holder of comprehensive data, yet the role which, on the other hand could be strictly limited by various restrictions to the production of reports to each user, which are compliant with the secrecy and checking rules and views of the information, which are applicable to each of the addressees.

The final definition of the role of these service providers will result without doubt as much from practice as from upcoming regulatory evolutions in the wake of the installation of the SEPA (Single European Payment Area).

B.2.2.3 Administration Outlines of the NP2 Data

For the installation of a payment system in a given scope of application, an administration outline must be defined.

By nature, this is according to the options adopted in the choice of material tools and implementation architectures.

The paragraphs hereinafter describe the essential elements necessary for the administration of NP2 processing chains and data.

The NP2 Service Provider Management Tool

The NP2 service provider management tool presents itself as a management and parameter setting interface for NP2 data, elements and processing operations, for which the NP2 service provider is the operator.

According to the situation, this relates to:
setting the parameters of the media issued and the bearer management tools (readers, servers, etc.)
setting the parameters of the buyer tools:
   payment terminal
   setting the parameters of the NP2 purchase server or purchase terminal,
   setting the parameters of the NP2 payment server(s)
setting the parameters and managing the NP2 merchant management server.
perfecting, administrating and managing the various databases: PFi, MA, RCI
etc.

The payment servers can be located either on the premises of the NP2 service provider or housed within the purchase terminals or purchase servers.

The NP2 Network Assets Management Server

The NP2 network assets management server is presented as a management and parameter setting interface for the NP2 data, elements and processing operations grouped in the same architecture, under the control of the same party.

The service provider and merchant are normally each a user as far as the network assets management server is concerned.

According to the situation, this relates to:
setting the parameters of the media issued and the bearer management tools (readers, servers, etc.)
setting the parameters of the buyer tools:
   payment terminal
   setting the parameters of the NP2 purchase server or purchase terminal,
   setting the parameters of the NP2 payment server(s)
setting the parameters and managing the NP2 merchant management server.
etc.

The NP2 Bearer Relations Management Server

The NP2 bearer relations management server is located within one of the parties of the device installed. As a general rule, this can relate to the issuer of the payment medium.

Considering the specific importance of these functionalities within the NP2 method, the main terms of use of this server are described hereinafter.

Constitution of Prepaid Funds

The bearer or persons connected to the bearer can, by using an interface dedicated to the connection with the NP2 bearer management program, available on the NP2 network assets management server, credit one or several allowances created by the bearer and made visible by himself/herself, after authentication on the management interface of his/her NP2 payment medium or of the NP2 network assets management server. These same persons can also grant a debit right to which the charge checking rules will be associated.

These credits or debit right are normally allocated to a general credit allowance or even to allowances or budgets dedicated to particular expenses (for example for certain categories of purchase: food, healthcare, certain goods, products or services; for certain periods corresponding for example to a holiday budget; etc.).

Subject to the laws and regulations protecting the confidentiality and, as required, subject to agreement by the bearer, the person having credited the NP2 account of the bearer or having granted him a direct debit right, can be made addressee of all or part of the operation reports relating to the payments charged to his/her account or on the prepaid amounts which he/she has credited.

Allocation of Expenses to Financings

The bearer can, by means of his/her management tool, create within his/her NP2 payment medium or on the NP2 network assets management server, allowances or budgets dedicated to particular expenses (for example for certain categories of purchase: food, healthcare, certain goods, products or services; for certain periods corresponding for example to a holiday budget; etc.).

Each of these allowances can be seen to allocate a particular source of financing: debit on one current account or another, allocation to a consumer credit account, charging to an account on which the bearer has a debit right, etc. the set-up of the charging rule being accompanied by the definition of the checking rules able to prevent the charge, set by the bearer or inherited from the financer or the drawer.

Definition of the Restrictions and Checks

In the NP2 method, the relevant parties, whether this relates to the bearer or the financers, are able to define within the NP2 payment medium or on the NP2 network assets management and payment servers, all checking or charging rules relating to the scope of application

These management rules are normally defined with reference to a typology of the objects or services likely to purchased, and with reference to the various sources of financing. They can be easily set-up and defined with relation to the allowances or budgets dedicated to particular expenses (for example for certain categories of purchase: food, healthcare, certain goods, products or services; for certain periods corresponding for example to a holiday budget; etc.).

Each of these allowances could be seen to allocate the charging rules and checking rules reserving the charge to a source of financing, particular in the case where a set of necessary conditions are met.

Lack of compliance with these conditions can be sanctioned either by the impossibility of purchase or by the automatic charge to the main account of the payment medium.

Eased Access to Controlled Financings

The NP2 method organizing a systematic check of the charge and enabling as from purchase, the division of the components of the price between different financers will be particularly adapted to the introduction in e-banking applications of debit rights granted by third party financers being in nature either public or private, professional or individual, voluntary or obliged donators, as well as any credit establishment or company.

The examples of application of the NP2 method are described in the part devoted to them hereinafter. In a general manner, the method eases access to controlled financings to a whole group of market participants. Systematically for these financers, the method will ease the management, due to the possibility brought about by the method to all relevant parties in managing, in a given scope of application, the rules and checks whose application will be systematic before any payment, and which will give rise to the production of the operation reports capable of being used in the form of structured data files, for account update and for checks.

This guarantee brought about by the NP2 e-banking system will ease in a practical, legal and psychological manner, the granting of debit rights to third party bearers on one current account or another, of direct debit right type.

The NP2 Merchant Relations Management Server

This server enables access to the NP2 merchant management programs described hereinbefore amongst the implementation tools.

This server can be integrated with the different parties according to the architecture retained. It is normally administrated by the merchant or the NP2 service provider. In this second hypothesis, the merchant user connects to this server, housed by the NP2 service provider.

The NP2 Purchase/Payment Server

This server is described hereinbefore amongst the implementation tools. This server can be integrated into the different material media and with the different parties according to the architecture retained.

If the unit comprised of the NP2 payment medium, NP2 payment terminal and NP2 purchase terminal connected together is technically capable of ensuring in satisfactory conditions the NP2 processing on the fly, this purchase server could be implemented on this equipment.

Without this, in a typically centralized architecture, the purchase server is normally administrated by the merchant, by the NP2 service provider or by any other party of the processing chain.

In this second hypothesis, the merchant user connects to this server, housed by the service providing party of the NP2 payment service.

The Settlement Payment Server

This server houses the NP2 operation reports management program and ensures the operations described hereinabove under the steps of the settlement.

This server can be integrated into the different material media and with the different parties according to the architecture retained.

Considering the confidentiality requirements, this server could naturally find its place on the premises of the NP2 service provider.

The NP2 Account Update Server

This server houses the NP2 operation reports management program and ensures the operations described hereinabove under the account update steps.

This server can be integrated into the different material media and with the different parties according to the architecture retained.

Considering the confidentiality requirements, this server could naturally find its place on the premises of the NP2 service provider.

### B.3 The Roll-Out Phases on a Scope of Application

B.3.1 The Initial Design Phase of the NP2 Processing Chains

The design phase of the NP2 processing chains, normally performed by an operator, NP2 payment services service provider includes:
The adaptation to the scope of application
The NP2 adaptation of the offer produced (adoption of bills, categorization of types of purchase, setting of associated rules, installation of NP2 marketing tools, etc.)
the choice of a processing architecture
the perfection of the NP2 settlement systems
the choice of an implementation topology of the databases and implantation of the NP2 programs
the definition of NP2 checking operations
the installation of PFi, MA, RIC databases
etc.

B.3.2 The Industrial Phase

The industrial roll-out phase of the NP2 processing chains to a given field normally includes:
the implementation of the NP2 in the material tools chosen and on the servers retained
the preparation of the payment media:
   issuing of payment media
   preparation of the NP2 payment terminals
the preparation of the NP2 purchase terminals
   installation of the NP2 purchase servers
   installation of the NP2 payment servers
the preparation of the information systems
   construction of the databases and their loading
   installation of the servers and network assets management
   implementation of the connection architecture of management servers
the installation of the settlement servers and NP2 operation reports management servers
   construction of the NP2 settlement systems from the account updating rules and standards of the inter-operated settlement systems
   construction of account update systems and exploitation systems for the operation reports generated.

B.3.3 The Exploitation Phase

The exploitation phase includes the following functions to be divided between the parties:
Customer management of the payment medium
Merchant management of the products and services offer
The payment processing chain
the settlement processing chain and payment of final payments
the operation reports processing chain

### C Examples of Application

### C.1 The Functionalities Offered by the NP2 Payment Systems

The new functionalities relating in particular to the customer, the financer(s) and the merchant.

C.1.1 For the Customer

For the customer, the applications drawn from the NP2 payment systems provide significant improvements and advantages.

For all bearers, the installation of an application on a particular field, capable of integrating different sources of financing likely to share the cost born by the purchase of goods and services of this particular field, provides, by construction, the advantages of being simple and unique.

The integration of a bearer management interface into the system enables this bearer to manage his/her budgets.

The possibility of setting rules and guaranteeing compliance with these rules by checks, contributes to this management. It offers bearers a powerful tool for managing his/her resources and simplifying home administrative tasks.

In addition, the fact of being equipped, via an NP2 e-banking payment medium, with controlled sources of financing, funded by prepayment or by drawing right, the use of which being strictly allocated and limited to certain types of expenses, will provide the possibility of accessing facilities offered by the most modern e-banking payment means in the new conditions to specific customers, in particular to people in difficulty.

C.1.2 For the Financer

Symmetrically, with reference to the financers, the possibility of opening a drawing right or applying a prepaid sum to a given bearer of an NP2 payment medium, whilst having the guarantee that this sum can only be used for certain expenses, certain types of purchase or under certain circumstances, constitutes a new prospect, applicable to numerous practical applications.

C.1.2.1 The Customer and Customer's Relatives

As previously indicated, in an NP2 system, the bearer of the payment medium can himself define the allowances attributed to certain expenses. Indeed, the bearer can be involved in the management of specific budgets for certain expenses, for example certain types of purchase or expenses made under certain circumstances.

In doing this, the modern NP2 payment medium enables him/her to recover the traditional habits of home management (holiday budget, healthcare budget, clothing budget, recreational budget, food budget, back-to-school budget, child budget, etc.).

In addition to the possibility of creating a specific allowance, the use of which being restricted to a certain type of expense or purchase, the bearer will also have the option of requesting his/her parents, friends or relatives for contributions to this allowance.

Thus, youths will be able to benefit for example, from a contribution from their parents or grandparents in the form of a budget for the purchase of educational books (with a specific specialized bookshop adhering to the NP2 system, with an online sales server, or even with a recreational products distribution group, also adherent to the NP2 system, and who will have specified, via their merchant management program, a coding relating to the category of “educational books/study books/scientific works”).

The economic and commercial interest in this possibility of allocating prepaid amounts to supervised and controlled expenses is evident.

This new option opens up a field of promotional actions for the distributors, aimed at “pocket money” which parents and relatives give to youths. For this, using this device enables secure management of given sums and thus eases the decision to give more significant sums of money in the form of pocket money.

This promotional field will be as promising as the merchant management tools which make up part of the NP2 system, offering a range of easy usage possibilities. It will thus be easy to distribute these offers via the bearer management tool, and to proceed to issuing the offers aimed at certain types of items, for certain types of financing, for certain periods; taking the same example: a particular reduction or gift certificate for expenses made from the prepaid allowances during the back-to-school period for study books or educational supplies.

The mechanism of the NP2 operation reports also offers powerful facilities for analyzing the commercial efficiency of these offers, enabling efficient targeting by these promotional operations.

In a very advantageous manner, such a system enables the replacement of the mechanics of “gift certificates”, which are today difficult to manage, and which require delicate manipulation at the check-out.

Similarly, a child or a legal representative of a senior citizen could allocate him/her a drawing right or prepaid budgets for daily expenses by specifying, if desired, that these sums cannot serve for purchasing alcohol or, for example, games expenses or expenses of an amount superior to that of X euros.

C.1.2.2 The Public Financer

For the public financers, the NP2 payment systems also present a particular interest.

This is particularly evident for the social security bodies or local governments, especially regarding their social aid expenses.

Regarding the particular case of healthcare expenses, an example of application of the NP2 system for a new management of the healthcare expense in the French social welfare system is described hereinafter.

In a more general manner, the NP2 system enables the relaunching in a satisfactory manner of the experiences of “service cards” distributed by the Town Halls or local authorities, which until now have had little success.

For example, for particular public sectors such as senior citizens, students or school pupils, the system enables the NP2 payment media to be issued for the payment of services provided by the public services, for example: public transport, access to group catering services, free access to formality or leisure services, etc.

For these particular public sectors, if the support is granted in the form of an amount paid periodically for certain types of expense, the availability of prepaid allowances dedicated to the expenses of this nature offers a particularly easy management system for distributing this financial assistance.

The production of operation reports upstream of payments also constitutes a major advantage for the institutions issuing this financial assistance. Indeed, it will be possible, by compiling the operation reports specifically defined for the account update requirements of institutions, to have efficient processing operations capable of satisfying the transparency and checking obligations of public spending.

These NP2 payment tools, used for the distribution of government assistance allocated to public or individual expenses, will also have the effect of mechanically reducing the possibilities of fraud as well as easing the checking and locating operations for evasion.

C.1.2.3 The Company for one of its Brokers

The use of e-banking tools in management by companies of purchases made by employees still poses a problem, whether the company is big or small.

In the state of the art, purchasing card systems which are only commonly used in a certain number of Countries, cannot provide a completely satisfactory solution from the moment that they operate on the classic payment process by balance and by using the processing chains which cannot traffic precise information on the nature of the goods or services purchased.

However, by design, in the NP2 system, the processing chains have this capacity and the operation reports management programs can be parametered in order to be inserted in an immediate and comprehensive manner into the information systems within the company, whether this relates to purchase and supply systems or account management systems (ERP).

In practice, for the manufacture of such purchasing cards in an NP2 environment, if a company has already proceeded to the organization work for these supply chains, it will suffice for it to adapt the MA codes from the codification system already rolled-out within the company.

If this organization work for the supply chains has not yet been performed, adopting a current standard codification (ECML type) is sufficient; concerning the use of operation reports for keeping records by the nature of the expenses, the accounting position codes to the desired degree of precision can be sufficient; for the use of these reports within the framework of cost accounting, the codification system installed in this cost accounting will for example be able to be retaken for the identification of the bearers authorized to keep an NP2 payment medium.

If a finer degree of precision for identifying the bearers is desired, the definition of the rights which were granted to him/her, the level of control associated to these rights and the degree of precision of the operation reports produced and the management of PFi and RIC data could be performed in connection with the company's human resources management system (H.R.M.).

For companies of a more modest size, i.e. micro businesses, use of the NP2 payment media will provide an even larger profit by easing management and reducing material and administrative tasks, even if in this event, the level of precision in report processing and the degree of control remains elementary.

The NP2 payment media therefore take part specifically in developing the use of its e-banking or online purchasing solutions within companies; they provide simplicity security and processing economies.

Another example can be given by the installation of a card system for managing the meals of a company's associates in one or several nearby restaurants or even within a network of restaurants (union, franchise network, restaurant chains, etc.). Cards equipped with a system for identifying the bearer or associate of a company, will thus enable this employee to eat in the restaurant(s) with which the company has signed an agreement, within the restrictions and conditions defined as charging and checking rules, guaranteeing the management of his/her meal by direct debit. According to the contractual framework adopted by the company, to which the employee will adhere in order to benefit from the card, the management supplement could be either paid off immediately to the restaurant owner by the associate or debited from his/her account. Due to this being managed by the company, any elements necessary for the checking of the managed meals will be sent to the company; however, the operations will result in a single periodic debit thus easing record keeping. An alternative to this card can enable third parties invited to “business meals” to be managed, with the reporting system installed upstream requiring from the inviting party, the name or reason of the persons invited.

C.1.2.4 Bank or Credit Company

For a bank or credit company, the roll-out of NP2-type solutions enables the service offer to be reformed towards the three previous parties: individuals, companies and the local authorities.

On a market today, which is the subject of growing criticism concerning the cost of payment services charged by credit establishments, it is important for these banking authorities to enhance the service provided and propose innovative offers.

In addition, the NP2 system provides by design, simple solutions in order to offer and manage new services which the banks have until now, attempted to offer to their customers, and which are regularly balanced by setbacks due to the complexity of its use for the customers and due to the management cost for the bank.

This being so, for example, numerous attempts to associate a payment card with gift certificates, reductions or loyalty services aimed at negotiating with retailer or distributor networks. The lack of a joint information system between these worlds which will provide the NP2 processing chains, has until now deprived these initiatives of any long-term success. For assessing the advantages of the NP2 system in managing such programs, refer to part C 3.1.3.

C.1.3 for the Merchant

The NP2 solutions also open up new prospects to the distributors, producers, retailers and merchants in their offers and capacities to be marketed.

C.1.3.1 BtoB Advantages

The NP2 payment solutions are initially designed to be rolled-out as new e-banking solutions.

However, they open up equally new and relevant prospects in B to B, where the choice of an NP2 payment server within the NP2 purchase server creates the new possibility of offering companies supply solutions which will communicate effectively and easily with their internal information systems, and especially their accounting system (ERP, etc.).

In BtoB, major progress will result in that the invention which provides for including the information necessary for this type of processing in the operations report, enables the ROIPEs to be used via the NP2 report management server, which is capable of producing various payment, checking and analysis reports with ease and the security that they are compliant with the legislations and rules imposed for the field.

At the price of initially setting the parameters, these NP2 online payment solutions can provide companies with the benefits generally expected from operations installing the supply chains, however with more ease.

This roll-out could become even simpler and quicker than the standards being installed by alliance mechanisms for NP2 operators with supply chain, ERP or CRM offers in order to define the PFi, MA and RIC codifications.

C.1.3.2 New Offers Dedicated to Specific Customers

One of the principles emerging from the NP2 process resides in the possibility, being new in this form, for the merchant to create specific cards for particular customers, for which the prepayment management facilities and the fullness of the tests performed during the purchase constitute decisive elements in accessing e-banking payment means regularly used. For the distributors, the option of issuing innovative payment cards to particular customer targets constitutes a major commercial asset.

In the field of major outlet distribution or in specialized distribution towards consumers, the choice of NP2 solutions enables innovation by an offer suited to the needs of the particular customer targets.

The examples given below on young customers or, the opposite, on older customers can be reproduced on different: persons of full age under guardianship, beneficiaries of government assistance, etc.

Granting of NP2 payment media by distributors to its customers will have the dual effect of increasing their purchasing power and securing their loyalty for expenses within the channels of these distributors or these distributor and retailer alliances.

Rapidly adopting these solutions can also constitute the differentiating factor which will finally offer these distribution companies the means to succeed in developing their banking service offers, initiated until now only on a small scale by major outlet groups.

### C.2 Evolution of the Payment Media

The NP2 method normally leads to an acceleration in the evolution of payment means. It must ease the evolution of applications on new media and the entrance of new industrial participants or operators and service providers.

C.2.1 For the Telecom Sector

The NP2 architecture offers a truly new prospect in the roll-out of payment solutions on material media originating from the world of telecommunications.

Computing power now available on mobile telephones, the possibility of contactless data exchanges, by different, secure communication protocols (WIFI, RFID, 3G, etc), the convergence of these PDA and mobile telephone tools etc., any evolution entered into makes these tools the natural links in an NP2 e-banking processing chain. At the price of implementing programs dedicated to the NP2 processing operations, different mobile telephone equipment will naturally take part in constructing industrial solutions for rolling-out these new payment services in multiple fields.

Reciprocally, this technology provides to a great extent the specific needs of the processing chains with the pre-existing solutions in terms of media, connection, processing and conservation of encrypted data.

For the NP2 operators, as for mobile telephone operators, an alliance is therefore natural and of reciprocal benefit;

C.2.2 Application to Payment Means

The introduction of the methods and the implementation of NP2 programs into the existing payment media is the first condition necessary for the development of the NP2.

In the state of the art, these media run the risk of being barely suitable for rolling-out the more complex solutions, fully exploiting the new method; it will be the same for the communication systems associated with these existing media.

The creation of value provided by the NP2 must enable the profitability conditions to be met, conditions which justify the modernization investment to be made, in order to satisfy the requirements of such applications.

This is how the distribution of innovations linked to payments means should accelerate: the development of the “contactless”, use of payment solutions from the PDA or “Smartphones”, which will build on its computing power and the communication capabilities of these personal assistants, whether the latter uses or not the GSM, UMTS or 3G networks, or any new “contactless” technology.

The power of the NP2 even enables two electronic applications of the technology to be conceived, in order to create virtual or limited payment media.

Creation of a Virtual Payment Medium

The NP2 device can also be implemented in a virtual “purse” format, adding a payment tool to the objects having an initial purpose other than that of payment.

A characteristic example of this is provided by the cards now serving as hotel room keys. The integration of an NP2 payment medium into this card enables checking in and checking out operations to be simplified on a large scale.

For taking reservations, hotel chains generally register reference numbers relating to a means of payment as a guarantee, sometimes a deposit, sometimes a price paid corresponding most often to a selection of services (room for x number of nights, breakfast included or not, meals with or without drinks, etc.) At the time of departure, the various consumptions made by the customer are added together, the prepaid services are deducted, and an overall bill is produced and the balance paid by the customer, often by means of a credit card.

By virtue of the implantation of the NP2 process into the card serving as the room key, it will be possible, upon the customer's arrival; to fund the payment media with a prepaid allowance adding together the services provided for in the package already paid for (equivalent to a voucher), as well as the characteristics of his/her credit card presented as a guarantee at reception upon arrival. During the stay, the customer uses his/her key as an identifier and mode of payment for the various services consumed. Those included in the prepaid package are charged to this key, and those not included are added together to be debited at the time of departure on the card presented upon arrival. At the end of the stay, payment is instant: the returned card enables a bill to be drawn up adding together all of the services, specifying their charge to the prepaid package and billing the extra amount to the credit card number chosen by the customer upon arrival.

Creation of a Limited Payment Medium

The method enables a “purchase token” to be manufactured, which can be very simply installed onto an NP2 payment medium as the opening of a financing service corresponding to a purchase credit, within a determined limit, under certain conditions of use (duration of validity, place), for certain products or in certain shops, for the purchase of certain items or even of a particular item.

The payment medium in this event becomes the equivalent of a gift certificate, a payment receipt or a withdrawal voucher, valid on an NP2 payment terminal also benefiting from the security of the authentication mode of the medium and the bearer.

This credit can be charged to the NP2 payment medium in various ways: at the checkout of a shop at the time of the connection of the payment medium to the payment terminal connected to the purchase server which thus issues the credit; by connection to the bearer management server before passing through the check-out. Previously, the credit could have been set up by the purchaser on his bearer management interface or even at the end of an online purchase, by deciding to pay by one of the sources of financing and by deciding to make his/her NP2 medium under this form, issue the practical equivalent of a receipt aimed at withdrawing the purchase; however, in this last situation, the passing the medium on the NP2 payment terminal for withdrawing the purchase is the equivalent to the operation being “successfully completed”, and will finalize the payment, which presents an evident advantage for the consumer.

C.2.3 In E-Commerce

The installation of NP2 purchase servers will provide electronic commerce with new promotional, marketing, market analysis and new customer prospecting tools, etc.

For consumers, companies or individuals, the NP2 method provides the prospect of new services and the reduction of upstream management costs. Its application could occur by various authentication tools provided by the state of the art, compatible with the NP2 tools, before connection to the NP2 purchase server, or even via a local reading terminal.

C.3 by Fields of Implementation

C.3.1 Source of Innovation for BtoC Distributors

This e-banking process offers a large variety of new commercial applications or innovations which provide unprecedented facilities in the management of classic commercial promotion methods.

C.3.1.1 Gift Certificates

Several of these commercial applications are directly linked to the payment process incorporating data relating to the object or the service purchased.

This specifically enables the management in a precise and yet economic manner with respect to processing operations, of a range of promotions, gift certificates and discount vouchers by targeting in a precise manner the relevant customers, and afterwards having a full view of the commercial impact of these promotional actions.

The gift certificate can be replaced by granting a prepaid credit valid in a specific manner for certain items, a certain period or in certain shops, etc. The operation reports mechanism enables the use of these vouchers to be monitored in a precise manner, and eases the analysis of their commercial efficiency.

C.3.1.2 Payment Cards Dedicated to Special Customers

Two examples are described herein.
persons of full age under guardianship

The population of persons of full age under guardianship and senior citizens under guardianship, regroups a growing number of people for who, today, the management systems of daily expenses remains difficult and very often experienced as humiliating. These people see themselves more often with a small savings for a limited period of time, allocated by parents or by their guardian.

Despite everything, this method leaves the problem of checking the prevention of certain purchases (games expenses, alcohol purchases, etc.).

However, these people generally have parents or relatives in their entourage, assuring them either periodic installments or a drawing right on one of their accounts on the condition that, in counterpart, the guarantees are allocated to them for the type of purchase for which their money can serve.

The NP2 payment media are precisely designed to provide this type of guarantee, as well as to ease the setting-up of a direct debit right or the period recharging of prepaid allowances.

By easing the payment for customers in a situation of weakness, the method contributes to enabling their consumer needs to be met and attracting the needs of “consuming for others”, corresponding to the desires of their children, parents or friends to enable them, remotely, to consume certain types of expenses in an easy yet supervised and limited manner.

Such payment media are also suited for the distribution of certain social assistance by government bodies coming to help this population group in their means of subsistence or in certain types of particular expenses.

Youths

Young customers in particular also take part in significant commercial initiatives organized around the distribution of “youth cards”. On the one hand, these cards enable special tariffs to be managed for these customers.

On the other hand, the process easily enables new prepayment facilities to be offered for the parents and relatives of these youths.

Thus, the distribution companies are also opening up a commercial field of action enabling “pocket money” given to youths by their parents and grandparents to be acquired by guaranteeing supervision of the expense being made on the prepaid amount by nature of the goods and services purchased.

It thus becomes possible for parents and relatives of the youth to give him/her the necessary money for the purchase, for example, of schoolbooks, free time or sporting equipment, for the payment of their food, etc. by monitoring that the money allocated to these various types of expense cannot be used for any other use.

The NP2 payment media are precisely designed to provide this type of guarantee, as well as to ease the setting-up of a direct debit right or the periodic recharging of prepaid allowances by third parties to the benefit of the bearer.

Such payment media are also suitable for distributing certain social assistance by government bodies granting financial assistance to youths or to certain categories of youths (students, unemployed, etc.) and for certain types of particular expense.

C.3.1.3 Retailer or Producer Unions

For such unions, the possibility of grouping together in order to offer a payment service of this new type is a true opportunity to change their image and obtain better acknowledgement, and therefore better customer activity, i.e. for targeted customers or specific types of consumption.

Direct application of the possibilities of the NP2 systems adapted to these unions is the setting-up of a system of loyalty points, accepted within this union and manageable in a particularly easy manner in this system. Indeed, the loyalty points can be managed as a source of financing, credited progressively with expenses according to a rule defined ad hoc; the credit accumulated in this allowance becomes released according to the conditions which are themselves also set by the NP2 RIC rules system: payment by charging on this line being only possible under certain conditions (shops, objects purchased, etc.).

Management of these loyalty points under this form will also have the advantage of standardizing the monitoring mechanism of this “near money” undergoing large developments, and which is beginning to become a source of doubt, even for the regulating authorities.

C.3.2 A to C

C.3.2.1 The Consumer Card for Public Financial Assistance

Due to the native capacities of checking the nature of the expenses and due to the precision of operation output, the NP2 solutions are particularly suited to managing public financial assistance.

According to the degree of detail and complexity provided by the rules and controls, this system will even take part in the management of financial assistance subjected to various conditions.

The periodic funding of prepaid accounts or allocation of drawing rights with associated limitation can be two means for spending this financial assistance via an NP2 medium.

This medium can be either exclusively devoted to managing the policies of a given authority (local government or authority services card), or even to grouping the financial assistance from various authorities aimed at the same group (students, unemployed, senior citizens, disabled, etc.).

The bearer medium of this financial assistance can be dedicated to this type of source of financing or even complement an additional source of financing debited from the current account of the bearer or prepaid by him/her. In this hypothesis for the creation of cards which are both personal and for the management of public financial assistance, the expenses performed over the amount of assistance allocated or outside of the conditions required can however be paid for by the same payment, balanced over several sources of financing. The use of this means by the beneficiaries is more discrete.

C.3.2.2 Healthcare Expenses

The case of managing healthcare expenses in France and the use of the “carte vitale” (French social insurance smart card) constitutes another excellent example of the advantages of the NP2 system;

As already stated hereinabove, the world of healthcare in France organizes the price of the healthcare expenses to be divided between various paying third parties and debtors.
the deterrent fee is the remaining part under the responsibility of the social insured party,
the social security fund bears a part of the update, variable according to the medication and according to whether it was prescribed by a doctor or not,
the mutual insurance company pays a share
in addition to additional benefits, as required,
in the event of extra-billing, the substitution in the pharmacy of a medication by a generic which is better updated must also be integrated, etc.

In practice, even with the use of the “carte vitale”, the debts are paid either by a “game of cards” during the payment or by the management of complex updating rules at the level of the central settlement and payment systems, or even by a raised cost premium for manual management.

In the NP2 outline, it is made easy for the customer, via the bearer interface, to group his/her various sources of financing onto the same medium.

Indeed, it is him/her, if given the possibility in a technically simplified manner, will be the one who has the best view of his/her various resources and social protection mechanisms. By being aware of this, he/she can become clearly responsible for his/her choices and judgments.

In practice, on leaving the pharmacy, the payment by a single NP2 card duly filled in and parametered will enable the payment of, for example:
aspirin prescribed by the treating doctor;
   paid of at 65% by the CPAM (Caisse Primaire d'Assurance Maladie—Local Sickness Insurance Fund)
   at 20% by the mutual insurance company
   the remaining 15% on a main account
medication with a blue label:
   charged at 35% to the CPAM
   covered at 30% by the mutual insurance company
   the remaining balance charged to the main account
but also the health and beauty products, for example:
   regular consumer items which are charged to the current account
   make-up products which could be, by the choice and rule set by the bearer, reserved to a charge on a budget (health and beauty) corresponding to a prepaid allowance.

The NP2 thus enables the charging to be differentiated item by item as well as at the same time, the charge to be checked or divided between sources of financing.

This mechanism will particularly take part in the field of Healthcare.

1-36. (canceled)

37. A method of electronic payment by a bearer to a merchant using a payment medium, comprising the steps of:
pre-storing data in the payment medium or in databases of a payment server, said pre-stored data being accessible through a link to a central system or on a local replication, said pre-stored data being organized as follows:
data relating to sources of financing or financers are stored in a bearer/financing database;
data relating to merchants and categories of items comprising products, goods and services are stored in a merchant/article (MA) database; and
data representing charging and checking rules, defined for each source of financing by the bearer of the payment medium or by a financer are stored in a rules and checks (RIC) database;
selecting applicable charging and checking rules by utilizing said pre-stored data for said each item presented for purchase using the payment medium by the payment server;
collating pre-stored data with data associated with said each item presented for purchase, data associated with conditions of the purchase, and said data relating to merchants and categories of items from the MA database by the payment server;
determining a source of financing for all or part of a price of said each item presented for purchase during a payment using the selected charging and checking rules and the collated pre-stored data by the payment server; and
performing successive charges for said each item presented for purchase during the payment based on the determined source of financing by the payment server.

38. The method of claim 37, wherein the step of performing successive charges comprises the step performing a charge on a fraction of the price of the product, good or service presented for purchase by the payment server, each fraction of the price chargeable to a different source of financing.

39. The method of claim 37, further comprising the step of generating and storing a report for each charge, the report associating said each charge to recording of said data associated with said each item presented for purchase in a database to permit verification of said each charge.

40. The method of claim 37, wherein the step of selecting the applicable charging and checking rules comprises the step of checking regularity and legitimacy of each charge with respect to rules selected by at least one of the following: the bearer, the merchant and the financer.

41. The method of claim 37, further comprising the steps of generating a settlement report for payment of each charge; generating a basic charging operation report for said each charge; managing the basic charging operation report for said each charge for use in subsequent verifications, analysis or statistical purposes; and storing the settlement report and the basic charging operation report in a database accessible by the payment server; and wherein the basic charging operation report integrates data items associated with the payment of said each charge and data items associated with verifications performed for said each charge.

42. The method of claim 41, wherein the step of managing the basic charging operation report comprises the step of organizing the basic charging report such that each addressee or recipient can receive information emanating from the basic charging report only in proportion to a knowledge right assigned to said each addressee.

43. The method of claim 37, further comprising the step of managing loyalty points on a dedicated source of financing among the sources of financing stored in the bearer/financing database, the loyalty points are accumulated progressively with each payment in compliance with the charging and checking rules stored in the RIC database and use of the loyalty points are monitored in accordance with the charging and checking rules stored in the RIC database.

44. The method of claim 43, further comprising the step of utilizing the loyalty points by drawing from said dedicated source of financing in compliance with the charging and checking rules stored in the RIC database which regulate use of the loyalty points by the bearer.

45. The method of claim 37, wherein the step of performing successive charges comprises the step of performing a charge in accordance with data representing the bearer's selection with respect to at least a source of financing to be charged for said each item presented for purchase, the data representing the bearer's selection is either pre-stored or collected during the payment.

46. The method of claim 37, wherein the step of performing successive charges comprises the step of performing a charge in accordance with data representing checks performed by the merchant, the data representing the checks performed by the merchant is either pre-stored or collected during the payment.

47. A system of electronic payment for items by a bearer to a merchant, the items comprising goods, products or services, the system comprising:
a payment medium unique to the bearer;
a payment server;
a payment terminal, connected to the payment server, reads and authenticates the payment medium, and transmits payment data to the payment server;
a purchase terminal, connected to the payment server, identifies the items purchased and transmits data identifying the items purchases the payment server; and
a data storage device, in the payment medium or in the payment server, accessible through a link to a central system or on a local replication, and comprises:
a bearer/financing database for storing data relating to the sources of financing or financers;
a merchant/article (MA) database for storing data relating to merchants and categories of items;
a rules and checks (RIC) database for storing data representing the charging and checking rules for each source of financing defined by the bearer of the payment medium or by a financer; and
wherein the payment server, for each item presented for purchase during a payment, utilizes the data stored in the data storage device to select an applicable charging and checking rules and collate the data stored in the data storage device with data associated with said each item presented for purchase, data associated with conditions of the purchase, and said data relating to merchants and categories of items from the MA database;
wherein the payment server determines a source of financing for all or part of a price of said each item presented for purchase during the payment using the selected charging and checking rules and the collated data; and
wherein the payment server performs successive charges for said each item presented for purchased during the payment based on the determined source of financing.

48. The system of claim 47, wherein the payment server performs each charge on a fraction of the price of the product, good or service presented for purchase, each fraction of price chargeable to a different source of financing.

49. The system of claim 47, wherein the payment server generates a report for each charge, the report associating said each charge to recording of said data associated with said each item presented for purchase in the storage device to permit verification of said each charge

50. The system of claim 47, wherein the payment server checks the regularity and legitimacy of each charge with respect to the rules chosen by at least one of the following: the bearer, the financer and the merchant.

51. The system of claim 47, wherein the payment server generates a settlement report for payment of each charge, generates a basic charging operation report for said each charge; manages the basic charging operation report for said each charge for use in subsequent verifications, analysis or statistical purposes, and stores the settlement report and the basic charging operation report in the data storage device; and wherein the basic charging operation report integrates data items associated with the payment of said each charge and data items associated with verifications performed for said each charge.

52. The system of claim 51, wherein the payment server manages the basic charging report such that each addressee or recipient can receive information emanating from the basic charging report only in proportion to a knowledge right assigned to said each addressee.

53. The system of claim 47, wherein the payment server manages loyalty points on a dedicated source of financing among the sources of financing stored in the bearer/financing database, the loyalty points are accumulated progressively with each payment in compliance with the charging and checking rules stored in the RIC database and use of the loyalty points are monitored in accordance with the charging and checking rules stored in the RIC database.

54. The system of claim 53, wherein the loyalty points can be directly used by drawing from said dedicated source of financing in compliance with the charging and checking rules stored in the RIC database which regulate use of the loyalty points by the bearer.

55. The system of claim 47, wherein the payment server performs a charge in accordance with data representing the bearer's selection with respect to at least a source of financing to be charged for said each item presented for purchase, the data representing the bearer's selection is either pre-stored or collected during the payment on the payment medium or payment terminal.

56. The system of claim 47, wherein the payment server performs a charge in accordance with data representing checks performed by the merchant, the data representing the checks performed by the merchant is either pre-stored or collected during the payment on the purchase terminal.

57. The system of claim 47, further comprising a management interface, dedicated to the bearer, to generate or modify the charging and checking rules or the sources of financing by the bearer.

58. The system of claim 47, further comprising a merchant management interface to generate or modify the charging and checking rules or the categories of goods, products or services by the merchant.

59. The system of claim 47, further comprising a financer management interface to generate or modify the charging and checking rules associated with a source of financing by the financer of said source of financing.

60. A remote system of electronic payment for items (goods, products or services) by a bearer to a merchant, the items comprising goods, products or services, the system comprising:
a payment medium, unique to the bearer groups, several sources of financing;
a purchase server identifies the items presented for purchase by the bearer;
a payment server connected to the purchase server receives data from the purchase server;
a data storage device, in the payment medium or in the payment server, accessible through a link to a central system or on a local replication, and comprises:
a bearer/financing database for storing data relating to the sources of financing or financers;
a merchant/article (MA) database for storing data relating to merchants and categories of items;
a rules and checks (RIC) database for storing data representing the charging and checking rules for each source of financing defined by the bearer of the payment medium or by a financer; and
wherein the payment server, for each item presented for purchase during a payment, utilizes the data stored in the data storage device to select an applicable charging and checking rules and collate the data stored in the data storage device with data associated with said each item presented for purchase, data associated with conditions of the purchase, and said data relating to merchants and categories of items from the MA database;
wherein the payment server determines a source of financing for all or part of a price of said each item presented for purchase during the payment using the selected charging and checking rules and the collated data; and
wherein the payment server performs successive charges for said each item presented for purchased during the payment based on the determined source of financing.

61. The system of claim 60, wherein the payment server performs each charge on a fraction of the price of the product, good or service presented for purchase, each fraction of price chargeable to a different source of financing.

62. The system of claim 60, wherein the payment server generates a report for each charge, the report associating said each charge to recording of said data associated with said each item presented for purchase in the storage device to permit verification of said each charge

63. The system of claim 60, wherein the payment server checks the regularity and legitimacy of each charge with respect to the rules chosen by at least one of the following: the bearer, the financer and the merchant.

64. The system of claim 60, wherein the payment server generates a settlement report for payment of each charge, generates a basic charging operation report for said each charge; manages the basic charging operation report for said each charge for use in subsequent verifications, analysis or statistical purposes, and stores the settlement report and the basic charging operation report in the data storage device; and wherein the basic charging operation report integrates data items associated with the payment of said each charge and data items associated with verifications performed for said each charge.

65. The system of claim 60, wherein the payment server manages the basic charging report such that each addressee or recipient can receive information emanating from the basic charging report only in proportion to a knowledge right assigned to said each addressee.

66. The system of claim 60, wherein the payment server manages loyalty points on a dedicated source of financing among the sources of financing stored in the bearer/financing database, the loyalty points are accumulated progressively with each payment in compliance with the charging and checking rules stored in the RIC database and use of the loyalty points are monitored in accordance with the charging and checking rules stored in the RIC database.

67. The system of claim 66, wherein the loyalty points can be directly used by drawing from said dedicated source of financing in compliance with the charging and checking rules stored in the RIC database which regulate use of the loyalty points by the bearer.

68. The system of claim 60, wherein the payment server performs a charge in accordance with data representing the bearer's selection with respect to at least a source of financing to be charged for said each item presented for purchase, the data representing the bearer's selection is either pre-stored on the purchaser server or collected during the payment and transmitted to the purchase server.

69. The system of claim 60, wherein the payment server performs a charge in accordance with data representing checks performed by the merchant, the data representing the checks performed by the merchant is pre-stored on the purchase server.

70. The system of claim 60, further comprising a management interface, dedicated to the bearer, to generate or modify the charging and checking rules or the sources of financing by the bearer.

71. The system of claim 60, further comprising a merchant management interface to generate or modify the charging and checking rules or the categories of goods, products or services by the merchant.

72. The system of claim 60, further comprising a financer management interface to generate or modify the charging and checking rules associated with a source of financing by the financer of said source of financing.
